(19) United States
(12) Patent Application Publication
(10) Pub. No.: US 2025/0266983 A1
(43) Pub. Date: Aug. 21, 2025

(54) SYSTEMS AND METHODS FOR CLASSIFYING ENCRYPTED DATA USING AN ENCRYPTED MACHINE LEARNING MODEL

(71) Applicant: REGENTS OF THE UNIVERSITY OF MICHIGAN, Ann Arbor, MI (US)

(72) Inventors: Kayvan Najarian, Northville, MI (US); Alexander Wood, Ann Arbor, MI (US); Cristian Minoccheri, Ann Arbor, MI (US); Emily Wittrup, Ann Arbor, MI (US); Jonathan Gryak, West Haven, CT (US); Richard Wilson, York (GB); Delaram Kahrobaei, Ann Arbor, MI (US)

(21) Appl. No.: 18/443,677

(22) Filed: Feb. 16, 2024

(51) Int. Cl. H04L 9/00; G06N 20/00; G06N 20/20

(52) U.S. Cl. CPC H04L 9/008; G06N 20/00; G06N 20/20

(57) ABSTRACT

Systems and methods for classifying encrypted data using an encrypted machine learning model are disclosed. An example method includes receiving, at one or more processors, encrypted data from a user that is encrypted in accordance with a first fully homomorphic encryption technique. The example method further includes analyzing, by the one or more processors executing an encrypted ML model that is encrypted in accordance with a second fully homomorphic encryption technique, the encrypted data to output an encrypted classification without decrypting the encrypted data. The example method further includes transmitting, by the one or more processors, the encrypted classification to a user computing device for decryption.

### STATEMENT REGARDING FEDERALLY SPONSORED RESEARCH OR DEVELOPMENT

This invention was made with government support under 2209546 awarded by the National Science Foundation. The government has certain rights in the invention.

### FIELD OF THE DISCLOSURE

The present disclosure relates generally to techniques for encrypted communications and, more particularly, to systems and methods for classifying encrypted data using an encrypted machine learning (ML) model.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Private classification is a growing concern in medical applications as more assisted decision making and diagnosis systems become commercially available. However, owners of these systems generally do not want to share their models, and hospitals generally do not want to share their patients' data. Thus, without a secure ability to share models and data, such systems may experience delayed adoption, which can negatively impact the quality and timeliness of the corresponding medical care patients receive.

Therefore, there is a need for systems capable of performing private classification using an encrypted model to enable more secure and reliable decision making and diagnosis of various patient conditions.

### SUMMARY OF THE INVENTION

In some aspects, the techniques described herein relate to a system for classifying encrypted data using an encrypted machine learning (ML) model, the system including: a memory storing a set of computer-readable instructions including an encrypted ML model; and a processor interfacing with the memory, and configured to execute the set of computer-readable instructions to cause the system to: receive encrypted data from a user that is encrypted in accordance with a first fully homomorphic encryption technique, analyze, by executing the encrypted ML model that is encrypted in accordance with a second fully homomorphic encryption technique, the encrypted data to output an encrypted classification without decrypting the encrypted data, and transmit the encrypted classification to a user computing device for decryption.

In some aspects, the techniques described herein relate to a system, wherein the set of computer-readable instructions, when executed, further cause the system to: train a ML model with a set of training encrypted data as inputs to output a set of training encrypted classifications of the set of training encrypted data; and encrypt the ML model using the second fully homomorphic encryption technique to create the encrypted ML model.

In some aspects, the techniques described herein relate to a system, wherein encrypting the ML model further includes: encrypt one or more parameters of the ML model using the second fully homomorphic encryption technique.

In some aspects, the techniques described herein relate to a system, wherein the encrypted ML model includes: (i) a Naïve Bayes model, (ii) a Decision Tree, or (iii) a Random Forest model.

In some aspects, the techniques described herein relate to a system, wherein the first fully homomorphic encryption technique or the second fully homomorphic encryption technique further includes a private key encryption technique.

In some aspects, the techniques described herein relate to a system, wherein the first fully homomorphic encryption technique is different from the second fully homomorphic encryption technique.

In some aspects, the techniques described herein relate to a system, wherein the encrypted data from the user includes: (i) a set of encrypted values, (ii) a set of additively homomorphic monotone functions, (iii) a set of indexes, (iv) a q1-bit integer, or (v) an n-tuple q1-bit integer.

In some aspects, the techniques described herein relate to a system, wherein the set of computer-readable instructions, when executed, further cause the system to: receive a second set of encrypted data from a second user that is encrypted in accordance with the second fully homomorphic encryption technique, and wherein the second set of encrypted data includes: (i) a feature index at a node, (ii) a database, or (iii) a private encryption key for the database.

In some aspects, the techniques described herein relate to a system, wherein the set of computer-readable instructions, when executed, further cause the system to: produce an encrypted update to a ML model with a set of training encrypted data as inputs from one or more users; transmit the encrypted update to each user of the one or more users for decryption; and update the ML model using the encrypted update.

In some aspects, the techniques described herein relate to a system, wherein the set of computer-readable instructions, when executed, further cause the system to: receive, from each user of a plurality of users, a training dataset encrypted using an independently generated key pair, in accordance with a multi-key, multi-hop fully homomorphic encryption technique; train, with the training datasets, a ML model using a ML training technique; receive encrypted test datasets from one or more users of the plurality of users; generate, by executing the ML model, encrypted outputs for each encrypted test dataset; and cause user computing devices of each of the one or more users to participate in on-the-fly, multiparty computation to decrypt one or more respective encrypted outputs of the encrypted outputs by transmitting the encrypted outputs to each respective user of the one or more users.

In some aspects, the techniques described herein relate to a system, wherein the set of computer-readable instructions, when executed, further cause the system to: receive, from a new user, a new training dataset encrypted using a new independently generated key pair, in accordance with the multi-key, multi-hop fully homomorphic encryption technique; and update the ML model with the new training dataset using the ML training technique without re-encrypting the training datasets.

In some aspects, the techniques described herein relate to a computer-implemented method for classifying encrypted data using an encrypted machine learning (ML) model, the method including: receiving, at one or more processors, encrypted data from a user that is encrypted in accordance with a first fully homomorphic encryption technique; analyzing, by the one or more processors executing an encrypted ML model that is encrypted in accordance with a second fully homomorphic encryption technique, the encrypted data to output an encrypted classification without decrypting the encrypted data; and transmitting, by the one or more processors, the encrypted classification to a user computing device for decryption.

In some aspects, the techniques described herein relate to a computer-implemented method, further including: training, by the one or more processors, a ML model with a set of training encrypted data as inputs to output a set of training encrypted classifications of the set of training encrypted data; and encrypting, by the one or more processors, the ML model using the second fully homomorphic encryption technique to create the encrypted ML model.

In some aspects, the techniques described herein relate to a computer-implemented method, wherein encrypting the ML model further includes: encrypting, by the one or more processors, one or more parameters of the ML model using the second fully homomorphic encryption technique.

In some aspects, the techniques described herein relate to a computer-implemented method, wherein the encrypted ML model includes: (i) a Naïve Bayes model, (ii) a Decision Tree, or (iii) a Random Forest model.

In some aspects, the techniques described herein relate to a computer-implemented method, wherein the first fully homomorphic encryption technique or the second fully homomorphic encryption technique further includes a private key encryption technique.

In some aspects, the techniques described herein relate to a computer-implemented method, wherein the first fully homomorphic encryption technique is different from the second fully homomorphic encryption technique.

In some aspects, the techniques described herein relate to a computer-implemented method, wherein the encrypted data from the user includes: (i) a set of encrypted values, (ii) a set of additively homomorphic monotone functions, (iii) a set of indexes, (iv) a q1-bit integer, or (v) an n-tuple q1-bit integer.

In some aspects, the techniques described herein relate to a computer-implemented method, further including: receiving, at the one or more processors, a second set of encrypted data from a second user that is encrypted in accordance with the second fully homomorphic encryption technique, and wherein the second set of encrypted data includes: (i) a feature index at a node, (ii) a database, or (iii) a private encryption key for the database.

In some aspects, the techniques described herein relate to a non-transitory computer readable medium including instructions for classifying encrypted data using an encrypted machine learning (ML) model that, when executed, may cause one or more processors to: receive encrypted data from a user that is encrypted in accordance with a first fully homomorphic encryption technique; analyze, by executing an encrypted ML model that is encrypted in accordance with a second fully homomorphic encryption technique, the encrypted data to output an encrypted classification without decrypting the encrypted data; and transmit the encrypted classification to a user computing device for decryption.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1A illustrates an example environment for classifying encrypted data using an encrypted ML model, in accordance with various aspects disclosed herein.

FIG. 1B illustrates an example system classifying encrypted data using an encrypted ML model including components of the example environment of FIG. 1A, and in accordance with various aspects disclosed herein.

FIGS. 2A-2G illustrate example methods for classifying encrypted data using an encrypted ML model, in accordance with various aspects disclosed herein.

### DETAILED DESCRIPTION

As previously mentioned, conventional diagnostic and decision-making techniques can suffer from security issues due to a lack of encryption and/or otherwise secure data transmission between data owners (e.g., hospitals) and model owners. The techniques of the present disclosure overcome issues associated with conventional techniques by facilitating fully encrypted data transmission and processing between data owners and model owners. More specifically, the present disclosure introduces a system including a data owner providing encrypted data as inputs to an encrypted ML model that outputs an encrypted classification, wherein the encryption of all data, models, and classifications is performed and/or otherwise in accordance with one or more fully homomorphic encryption (FHE) techniques. This system/architecture collectively eliminates and/or reduces the drawbacks of conventional techniques by creating a more secure data transmission and processing pipeline that ensures the privacy of data owners and model owners alike.

Thus, in accordance with the above, and with the disclosure herein, the present disclosure includes improvements in computer functionality or in improvements to other technologies at least because the disclosure describes that, e.g., a server (e.g., a central server, model server), or otherwise computing device (e.g., a user computing device), is improved where the intelligence or predictive ability of the server and/or computing device is enhanced by a trained and encrypted ML model. These models, executing on the server and/or user computing device, are able to accurately and securely determine data classifications for encrypted data received from a user (e.g., data owner). That is, the present disclosure describes improvements in the functioning of the computer itself or “any other technology or technical field” because a server and/or user computing device, is enhanced with the trained and encrypted ML model to securely determine data classifications by processing the encrypted data to output an encrypted classification that improves a user's ability to evaluate/analyze the encrypted data without compromising the security of the data. This improves over the prior art at least because existing systems lack such encrypted data interpretation and/or encrypted classification output functionality and are generally unable to securely analyze input data to output classifications and/or are unable to analyze encrypted data and/or output an encrypted classification for decryption only by the data owner.

As mentioned, the model(s) may be trained using machine learning and may utilize machine learning during operation. Therefore, in these instances, the techniques of the present disclosure may further include improvements in computer functionality or in improvements to other technologies at least because the disclosure describes such models being trained with a plurality of training data (e.g., 10,000 s of training data corresponding to encrypted data, etc.) to output the encrypted classification(s) configured to improve the user/operator's ability to evaluate/analyze the encrypted data without compromising the security of the data.

Moreover, the present disclosure includes effecting a transformation or reduction of a particular article to a different state or thing, e.g., transforming or reducing the data security of encrypted data analysis from a non-optimal or error state (e.g., data requiring decryption prior to analysis) to an optimal state (e.g., analyzing encrypted data while encrypted) by training a ML model with encrypted training data to output encrypted training classifications.

Still further, the present disclosure includes specific features other than what is well-understood, routine, conventional activity in the field, or adding unconventional steps that demonstrate, in various embodiments, particular useful applications, e.g., analyzing, by the one or more processors executing an encrypted ML model that is encrypted in accordance with a second fully homomorphic encryption technique, the encrypted data to output an encrypted classification without decrypting the encrypted data, and/or transmitting, by the one or more processors, the encrypted classification to a user computing device for decryption, among others.

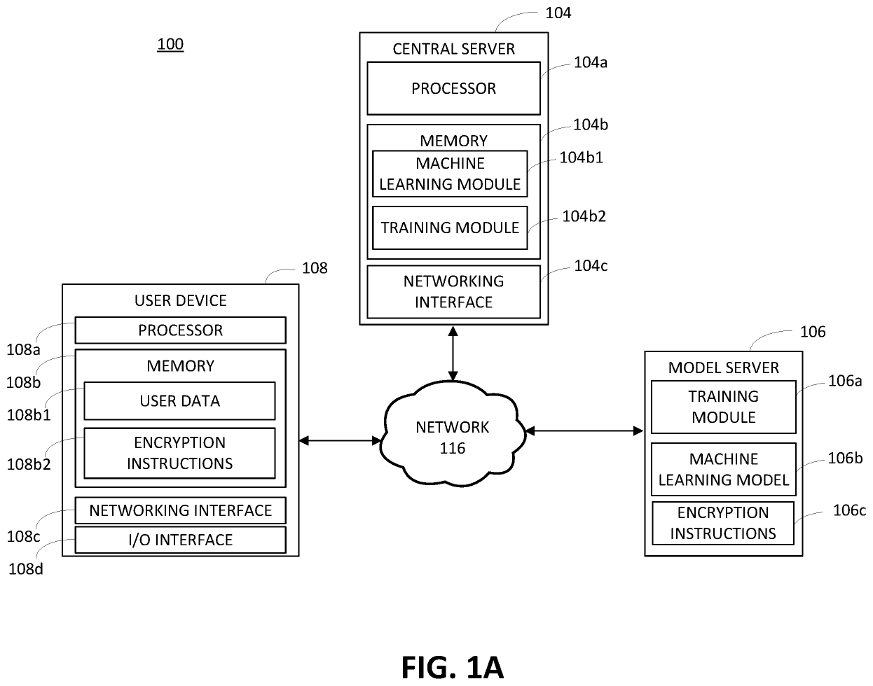

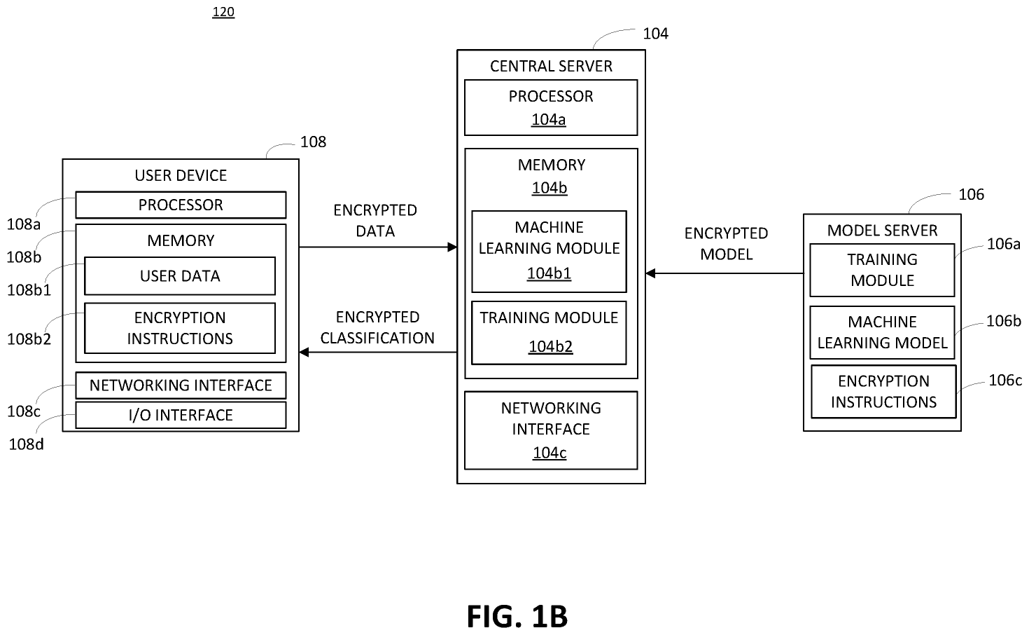

To provide a general understanding of the system(s)/components utilized in the techniques of the present disclosure, FIGS. 1A and 1B illustrate, respectively, an example environment 100 for classifying encrypted data using an encrypted ML model and an example system 120 classifying encrypted data using an encrypted ML model including components of the example environment 100. Accordingly, FIG. 1A provides a general overview of the example environment 100 components, and FIG. 1B illustrates the components and their respective functions in greater detail. Moreover, it should be appreciated that the example environment 100 may include more/fewer components and/or the example system 120 may include communications between any suitable combination/configuration of the components from the example environment 100.

In any event, FIG. 1A illustrates an example environment 100 for classifying encrypted data using an encrypted ML model, in accordance with various aspects disclosed herein. It should be appreciated that the example environment 100 is merely exemplary and that alternative or additional embodiments are envisioned.

In reference to FIG. 1A, the example environment 100 may be a distributed computing environment where the encrypted data and encrypted ML model are located/stored in any suitable location(s) and may be transmitted across a network 116 to the various components, as necessary. In particular, the example environment 100 includes a central server 104, a model server 106, and a user device 108. Broadly, the user device 108 may store and transmit encrypted user data 108b1 to the central server 104 across the network 116, and the central server 104 may also receive an encrypted, trained ML model 106b from the model server 106. Upon receipt of both the encrypted user data 108b1 and the encrypted, trained ML model 106b, the central server 104 may output encrypted classifications and/or any other suitable information and transmit the output(s) to the user device 108. The user device 108 may, for example, display the data output from the central server 104 for viewing by a user, such as the user that provided and/or authorized the encrypted data to be transmitted to the central server 104 for analysis by the encrypted ML model 106b. However, in certain embodiments, the user device 108 may transmit data directly to the model server 106 for analysis using the ML model 106b.

While in various examples herein a central server is shown, the techniques herein may be implemented in a distributed processing model, such as what is termed a federated computational model. For example, computations performed by FHE trained ML models herein may be performed, in some architectures, across decentralized devices or servers. In some such examples, each distributed device or server may include an FHE trained ML model and a central server may coordinate operations across these distributed devices. That is, while centralized data consumption examples are described and illustrated, in some implementations, fully homomorphic encrypted data may be retained locally at a user device or server, and a central server may deploy instantiations of the fully homomorphically encrypted machine learning models to that user device or server or consuming the data without decryption.

Further, as referenced herein, “encrypted data” may be or include data representative of and/or otherwise corresponding to (i) a set of encrypted values, (ii) a set of additively homomorphic monotone functions, (iii) a set of indexes, (iv) a q₁-bit integer, or (v) an n-tuple q₁-bit integer. Further, the “training data” or “training encrypted data” may be or include similar data values as the encrypted data. Moreover, while the data and actions described herein may be referenced in the context of medical data, it should be appreciated that this is for the purposes of discussion only. Thus, the data and actions described herein may apply to any suitable field and/or types of data.

Generally speaking, the central server 104 may include a processor 104a, a memory 104b, and a networking interface 104c. The memory 104b may include a ML module 104b1 and a training module 104b2. The model server 106 may include a training module 106a, a ML model 106b, and encryption instructions 106c. The user device 108 may include a processor 108a, a memory 108b, a networking interface 108c, and an input/output (I/O) interface 108d. The memory 108b may include user data 108b1 and encryption instructions 108b2.

The user device 108 may store user data 108b1 that may be sensitive and/or otherwise should not be transmitted outside of the user device 108 while unencrypted (e.g., patient medical data). Accordingly, the user device 108 may also store encryption instructions 108b2 configured to encrypt the user data 108b1 prior to transmitting the user data 108b1 to the central server 104 for subsequent analysis. More specifically, the encryption instructions 108b2 may include instructions configured to encrypt the user data 108b1 in accordance with a fully homomorphic encryption technique.

The user device 108 may transmit the encrypted user data 108b1 to the central server 104, where the central server 104 may apply/utilize the ML module 104b1 and/or the training module 104b2 to the encrypted user data 108b1. The central server 104 may also receive an encrypted ML model 106b from the model server 106, and the central server 104 may then input the encrypted user data 108b1 into the encrypted ML model 106b. In particular, the central server 104 may execute the encrypted ML model 106b via the ML module 104b1 to analyze the encrypted user data 108b1 and generate encrypted classification(s) as output.

The model server 106 may include a training module 106a, a ML model 106b, and encryption instructions 106c. The training module 106a may utilize input training data (e.g., sets of training encrypted data) to train the ML model 106b to generate the training outputs (e.g., training sets of classifications). The ML model 106b may generally implement and be trained using machine learning (ML) techniques and may include instructions configured to determine a classification corresponding to encrypted user data 108b1. The encryption instructions 106c may generally include instructions configured to encrypt the ML model 106b prior to transmitting the ML model 106b to the central server 104 for subsequent execution. More specifically, the encryption instructions 106c may include instructions configured to encrypt the ML model 106b in accordance with a fully homomorphic encryption technique, for example, by encrypting the weights, parameters, and/or other suitable values associated with the ML model 106b. In certain embodiments, the encryption instructions 106c may encrypt the ML model 106b in accordance with a fully homomorphic encryption technique that is different from the fully homomorphic encryption technique used to encrypt the user data 108b1.

The central server 104 may include a ML module 104b1 and a training module 104b2 that may generally be configured to collectively train, re-train, and/or update the ML model 106b. The ML module 104b1 may receive input encrypted user data 108b1 (e.g., data from a hospital) and may execute the encrypted ML model 106b to generate encrypted classification(s). The training module 104b2 may utilize new input data (e.g., new encrypted data) to re-train/update the ML model 106b after training at the model server 106 to generate outputs (e.g., classifications) based on the prior training dataset and the new input data.

The user device 108 may generally be a mobile device, laptop/desktop computer, wearable device, and/or any other suitable computing device that may enable a user to view the data transmitted from the central server 104. The user device 108 may include one or more processors 108a, a memory 108b, a networking interface 108c, and an input/output (I/O) interface 108d. The user device 108 may receive the encrypted classification(s) from the central server 104 via the networking interface 108c, decrypt the encrypted classification(s), and may display the decrypted classification(s) to the user via a display or other output device that is included as part of the I/O interface 108d. In certain embodiments, the user may interact with the user device 108 to view various aspects of the classification(s) received from the central server 104, communicate with the central server 104, and/or perform other actions (e.g., contacting a patient) in response to receiving the user interaction.

To provide a better understanding of the communications and general functionality of the components of the example environment 100, FIG. 1B illustrates an example system 120 for classifying encrypted data (e.g., user data 108b1) using an encrypted ML model (e.g., ML model 106b) including components of the example environment 100 of FIG. 1A, and in accordance with various aspects disclosed herein. Generally, example system 120 of FIG. 1B includes the central server 104 receiving data transmissions from the model server 106 and the user device 108 and generating and transmitting outputs to the model server 106 and the user device 108 based on those data transmissions.

For example, the model server 106 may transmit an encrypted ML model 106b to the central server 104, and the user device 108 may transmit encrypted data 108b1 to the central server 104. The central server 104 may analyze the encrypted data 108b1 using the encrypted ML model 106b to generate an encrypted classification, which the central server 104 may transmit to the user device 108 for decryption, in accordance with the encryption instructions 108b2.

In this manner, each party to the data transmissions/analysis may benefit from the execution of such transmission/analysis without exposing and/or otherwise risking their contributed data to any other participating party. Namely, the user of the user device 108 (e.g., a hospital, a physician, business owner, etc.) may securely transmit their user data 108b1 to the central server 104 to receive a classification without the central server 104 owner/operator and/or the model server 106 owner/operator receiving an unencrypted/decrypted version of the user data 108b1 or the resulting classification. Similarly, the owner/operator of the model server 106 may securely transmit their ML model 106b to the central server 104 to continually update/re-train/train and/or otherwise improve the ML model 106b without the central server 104 owner/operator and/or the user of the user device 108 receiving an unencrypted/decrypted version of the ML model 106b (e.g., unencrypted/decrypted model parameters, weights, etc.).

Moreover, while the techniques described herein may apply to a wide variety of scenarios involving sensitive, encrypted data and/or models, a few illustrative example scenarios may provide further clarification regarding the types of interactions/actions taking place, as described herein.

For example, in a first scenario, a hospital H may have a private database of patient data, D, which cannot be shared with an external entity. A research center C would like to use D to construct a machine learning model (e.g., ML model 106b), for example to build a function F to calculate a risk assessment score or perform actuarial analyses. In practice, C could be a research center, another hospital, a pharmaceutical company, an insurance company, and/or any other third party. Additionally, C may be reluctant to share the function, F, with H. Such a scenario can occur quite often, as researchers find it difficult to train generalizable models due to the lack of public data.

In a second scenario, C may have a collection of multivariate functions Fᵢ: xⁿ→Y, representing a specific machine learning algorithm (e.g., ML model 106b), while H has inputs x₁, x₂, . . . , xₙ (e.g., user data 108b1) representing a patient x's medical data. The set of known functions, F={Fi}ᵢ₌₁^{k} are expected to predict a diagnosis or prognosis for x, for example, the chances of patient x having Parkinson's, cancer, a heart attack, etc.

The difference between this second scenario and the first scenario is that, in the second scenario, F is assumed to be a known function (e.g., it is known how to calculate Glasgow Coma Scale (GCS) using eye, verbal, and motor responses). Regardless, the example system 120 may be configured to apply F in either scenario on both encrypted and unencrypted data to generate outputs. These outputs may be or include, for example, “health metrics”, “severity scores”, other clinical functions typically computed as a linear combination of privacy-protected factors, such as quantitative clinical or physiological patient data with a set of weights (coefficients) and/or any other suitable classifications corresponding to the input data.

As previously mentioned, and in very general terms, a potential exchange between the hospital H (e.g., user of user device 108) and a research center C (e.g., owner/operator of model server 106) may proceed in the following manner. H may encrypt data, x₁, x₂, . . . , xₙ, of a particular patient x with a fully homomorphic encryption technique E and may send the encrypted values ε(x₁), ε(x₂), . . . , ε(xₙ) to C. C may apply the private function F to the encrypted data, thereby computing F (E (x₁), ε(x₂), . . . , ε(xₙ)). Due to the fully homomorphic property of E, this computation is equal to ε(F (x₁, x₂, . . . , xₙ)). Next, C may send this result to H, who may decrypt the value and thus recover F (x₁, x₂, . . . , xₙ). H may then send this decrypted value back to C. Based on the received evaluation of F, H may have a diagnosis or risk assessment for patient x. Thus, C never learns the patient x's data and H never learns the function F.

In any event, the processor 104a may interface with the memory 104b to access/execute the ML module 104b1, the training module 104b2, and/or any other instructions stored therein (e.g., an operating system). For example, the processor 104a may access the ML module 104b1 to execute the encrypted ML model 106b configured to receive encrypted data (e.g., user data 108b1) as input and to output an encrypted classification based on the encrypted data, as discussed herein. The processor 104a may also access the training module 104b2 to update, re-train, and/or train the encrypted ML model 106b based on encrypted data (e.g., user data 108b1) received from the user device 108 that the training module 104b2 may use, in conjunction with the encrypted classification output by the encrypted ML model 106b to generate/apply an encrypted update. It should be appreciated that one or more other applications are envisioned. Moreover, it should be understood that any processor (e.g., processor 104a, 108a), user interface (e.g., I/O interface 108d), and/or memory (e.g., memory 104b, 108b) referenced herein may include one or more processors, one or more user interfaces, and/or one or more memories.

The user device 108 and the model server 106 may execute the encryption instructions 108b2, 106c to encrypt/decrypt the data transmitted to the central server 104 and/or received from the central server 104. For example, the user device 108 may execute the encryption instructions 108b2 to encrypt the user data 108b1 using a first fully homomorphic encryption technique prior to transmitting the user data 108b1 to the central server 104 and to decrypt the encrypted classification received from the central server 104. In certain embodiments, the encrypted data from the user may include: (i) a set of encrypted values, (ii) a set of additively homomorphic monotone functions, (iii) a set of indexes, (iv) a q₁-bit integer, or (v) an n-tuple q₁-bit integer.

Moreover, while various examples are described herein of performing FHE on user data, it will be appreciated that in any of the examples herein the FHE may be performed on a subset of the user data, wherein the subset is to be consumed in accordance with the methods and techniques herein. In some examples, the user data may be encrypted using an FHE technique, and the data sent to the ML model trained and/or encrypted in accordance with the techniques herein may include other data that is not encrypted by an FHE technique. In either case, the accompanying data not encrypted by an FHE technique may include metadata (such as, inter alia, data indicating that an FHE technique was used), data encrypted using non-FHE techniques, and/or non-encrypted data.

The model server 106 may execute the encryption instructions 106c to encrypt the ML model 106b using a second fully homomorphic encryption technique prior to transmitting the ML model 106b to the central server 104 and to decrypt any updates to the ML model 106b or other data received from the central server 104. In certain embodiments, the first fully homomorphic encryption technique may be different from the second fully homomorphic encryption technique. Of course, it should be appreciated that, in some embodiments, the first fully homomorphic encryption technique may be identical to the second fully homomorphic encryption technique.

Regardless, the memories 104b, 108b may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The example system 120 may further include a user interface (e.g., I/O interface 108d) configured to present/receive information to/from a user. The user interface included as part of the I/O interface 108d may include a display screen (not shown) and I/O components (e.g., ports, capacitive or resistive touch sensitive input panels, keys, buttons, lights, LEDs). According to some embodiments, a user may access the example system 120 via the user interface to review outputs from the central server 104 (e.g., encrypted ML model 106b), make various selections, and/or otherwise interact with the example system 120.

In some aspects, the example system 120 may perform the functionalities as discussed herein as part of a “cloud” network or may otherwise communicate with other hardware or software components within the cloud to send, retrieve, or otherwise analyze data. Thus, it should be appreciated that the example system 120 may be in the form of a distributed cluster of computers, servers, machines, or the like. In this implementation, a user may utilize the example system 120 as part of an on-demand cloud computing platform. Accordingly, when the user interfaces with the example system 120 (e.g., by interacting with an input component of the I/O interface 108d), the example system 120 may actually interface with one or more of a number of distributed computers, servers, machines, or the like, to facilitate the described functionalities.

In certain aspects, components of the example system 120 may communicate and interface with an external server and/or external devices (e.g., user device 108) via a network(s) (e.g., network 116). The network(s) 116 used to connect the components of the example system 120 to one another and/or components of the example system 120 to external server(s)/device(s) may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). Moreover, the external server(s)/device(s) may include a memory as well as a processor, and the memory may store an operating system capable of facilitating the functionalities as discussed herein as well as the ML module 104b1, the training module 104b2, encryption instructions 106c, 108b2, and/or any other suitable instructions described herein or combinations thereof.

Additionally, it is to be appreciated that a computer program product in accordance with an aspect may include a computer usable storage medium (e.g., standard random access memory (RAM), an optical disc, a universal serial bus (USB) drive, or the like) having computer-readable program code embodied therein, wherein the computer-readable program code may be adapted to be executed by the processor(s) 104a, 108a (e.g., working in connection with the corresponding operating system(s)) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some aspects, the computer program product may be part of a cloud network of resources.

Moreover, to facilitate the encrypted data processing described herein, the training module 106a, 104b2 may be configured to utilize artificial intelligence (AI) and/or machine learning (ML) techniques to train the ML model 106b. The training module 106a, 104b2 may generally employ supervised or unsupervised machine learning techniques, which may be followed or used in conjunction with reinforced or reinforcement learning techniques. As noted above, in some embodiments, the central server 104, the model server 106, and/or other computing device(s) may be configured to implement machine learning, such that the central server 104, the model server 106, and/or other computing device(s) “learns” to analyze, organize, and/or process data through the ML model 106b without being explicitly programmed. Thus, the training module 106a, 104b2 may train the ML model 106b to automatically analyze encrypted data (e.g., user data 108b1) from a user device (e.g., user device 108), and thereby enable the central server 104, the model server 106, and/or other computing device(s) to automatically process encrypted data without requiring manual intervention.

In some embodiments, at least one of a plurality of machine learning methods and algorithms may be applied, which may include but are not limited to: linear or logistic regression, instance-based algorithms, regularization algorithms, decision trees, Bayesian networks, naïve Bayes algorithms, cluster analysis, association rule learning, neural networks (e.g., convolutional neural networks (CNN), deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of a plurality of categorizations of machine learning, such as supervised learning, unsupervised learning, and reinforcement learning. Of course, it should be appreciated that the machine learning models and techniques utilized herein may be or include any suitable models or techniques, such as variations CNNs (e.g., residual neural network or attention-based network) and/or recurrent neural networks (RNNs) (e.g., long short-term memory networks, gated recurrent units (GRUs), transformer networks, and/or other networks with/without an attention mechanism).

In one embodiment, the training module 106a, 104b2 may employ supervised learning techniques, which involves identifying patterns in existing data to make predictions about subsequently received data. Specifically, the training module 106a, 104b2 may “train” the ML model 106b using training data, which includes example inputs (e.g., reference/training encrypted data) and associated example outputs (e.g., corresponding training encrypted classifications). Based upon the training data, the training module 106a, 104b2 may cause the ML model 106b to generate a predictive function which maps outputs to inputs and may utilize the predictive function to generate machine learning outputs based upon data inputs. The example inputs and example outputs of the training data may include any of the data inputs or machine learning outputs described above. In the example embodiment, a processing element may be trained by providing it with a large sample of data with known characteristics or features.

In another embodiment, the training module 106a, 104b2 may employ unsupervised learning techniques, which involves finding meaningful relationships in unorganized data. Unlike supervised learning, unsupervised learning does not involve user-initiated training based upon example inputs with associated outputs. Rather, in unsupervised learning, the training module 106a, 104b2 may cause the ML model 106b to organize unlabeled data according to a relationship determined by at least one machine learning method/algorithm employed by the training module 106a, 104b2. Unorganized data may include any combination of data inputs and/or machine learning outputs as described above.

In yet another embodiment, the training module 106a, 104b2 may employ reinforcement learning techniques, which involves optimizing outputs based upon feedback from a reward signal. Specifically, the training module 106a, 104b2 may cause the ML model 106b to receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Of course, other types of machine learning techniques may also be employed, including deep or combined learning techniques.

After training, the ML model 106b and/or other machine learning programs (or information generated by such machine learning programs) may be used to evaluate additional data. Such data may be and/or may be related to the encrypted data (e.g., user data 108b1) and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset. Such trained machine learning programs (e.g., trained ML model 106b) may, therefore, be used to perform part or all of the analytical functions of the methods described elsewhere herein.

It is to be understood that supervised machine learning and/or unsupervised machine learning may also comprise retraining, relearning, or otherwise updating models with new, or different, information, which may include information received, ingested, generated, or otherwise used over time. Further, it should be appreciated that, as previously mentioned, the training module 106a, 104b2 may train the ML model 106b to output encrypted classifications and/or any other values or combinations thereof using artificial intelligence (e.g., a ML model of the ML model 106b) or, in alternative aspects, without using artificial intelligence.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

In particular, the training module 106a may train the ML model 106b using any suitable ML technique with a set of training encrypted data as inputs to output a set of training encrypted classifications of the set of training encrypted data. Further, once the training module 106a has trained the ML model 106b, the model server 106 may execute the encryption instructions 106c to encrypt the trained ML model 106b using a fully homomorphic encryption technique to create an encrypted, trained ML model 106b.

In certain embodiments, the model server 106 may only transmit the ML model 106b to the central server 104 after the ML model 106b has been trained by the training module 106a and encrypted in accordance with the encryption instructions 106c. Further, in certain embodiments, the encrypted, trained ML model 106b may be updated/re-trained/trained by the training module 104b2 of the central server 104. In some embodiments, the fully homomorphic encryption techniques described herein to encrypt the ML model 106b, the user data 108b1, and/or any other data may include a private key encryption technique.

However, in some embodiments, the encrypted, trained ML model 106b may be updated/re-trained/trained by the training module 106a of the model server 106. For example, the central server 104 may execute the ML module 104b1 and generate/produce an encrypted update to the ML model 106b with a set of training encrypted data as inputs from one or more users (e.g., using one or more user devices 108). The central server 104 may transmit the encrypted update to each user and may also transmit the encrypted update to the model server 106, where the ML model 106b may be updated with the encrypted update by the training module 106a. In certain embodiments, the model server 106 may decrypt the encrypted update prior to training the ML model 106b. In some embodiments, the central server 104 may apply and/or otherwise update the ML model 106b using the encrypted update.

Furthermore, the model server 106 and/or the central server 104 may train the ML model 106b in a manner that enables new users to contribute to the training of the ML model 106b without affecting the encrypted data that has been used previously to train the ML model 106b. The central server 104 and/or model server 106 may receive from each user a training dataset encrypted using an independently generated key pair, in accordance with a multi-key, multi-hop fully homomorphic encryption technique. The central server 104 and/or model server 106 may use the training datasets to train the ML model 106b using a ML training technique. The central server 104 may then receive encrypted test datasets from each user and generate encrypted outputs for each encrypted test dataset using the ML model 106b. The central server 104 may then cause the user devices (e.g., user device 108) of each of the users to participate in on-the-fly, multiparty computation to decrypt encrypted outputs by transmitting the encrypted outputs to each respective user. After this training process is completed, the central server 104 may receive, from a new user, a new training dataset encrypted using a new independently generated key pair, in accordance with the multi-key, multi-hop fully homomorphic encryption technique. The central server 104 and/or the model server 106 may update the ML model 106b with the new training dataset using a ML technique without re-encrypting the training datasets originally used to train the ML model 106b. Thus, the example system 120 may continually update/re-train the ML model 106b without requiring re-encryption/bootstrapping of the previous encrypted datasets, and without requiring any keys to be replaced/updated.

Additionally, or alternatively, the example system 120 may allow direct transmissions between the user device 108 and the model server 106 without compromising the security of data transmitted and/or stored on/by the user device 108 and/or the model server 106. As an example, the example system 120 may enable a fully homomorphic private classification technique using a Naïve Bayes technique. Broadly speaking, such a classification technique may include a model owner/operator creating a learned/trained model using a Naïve Bayes technique, the model owner/operator encrypting the learned/trained model using a fully homomorphic private key encryption technique, and the data owner publishing the encrypted learned/trained model. The classification technique may further include a data owner calculating encrypted class probabilities based on their private data, and the data owner determining a final classification using a privacy-preserving argmax protocol, as described herein.

More specifically, and as an initial matter, assume that a data owner (e.g., utilizing user device 108) intends to classify their vector X which contains q features based on a learned model w owned by a classification model owner/operator (e.g., utilizing model server 106). The group of classes G may include r distinct classes, G₁ . . . . Gᵣ. Importantly, during this classification technique, the classification model owner/operator should learn no unnecessary information about the input data (e.g., user data 108b1) provided by the data owner, and the data owner should learn nothing but the predicted class index of X.

Regardless, there may be a certain amount of information which the data owner must know in order to carry out the classification technique. Namely, the data owner must know that the data vector X has p features and that there are exactly r classes. However, the data owner should not be able to deduce any information about the conditional class probabilities associated with the q features or the r class probabilities.

Because the classification model owner/operator has already computed/generated a learned/trained model, the classification model owner/operator may prepare two tables. First, the classification model owner/operator may prepare table P represented as a column vector of degree r where Pᵢ=Pᵣ(G=Gᵢ), the prior probability on class Gᵢ. Next the classification model owner/operator may prepare a table T as an r×q matrix where entry Tᵢⱼ represents Pᵣ(X=Xᵢ|G=Gᵢ).

Accordingly, the private, fully homomorphic Naïve Bayes classification technique may proceed with the classification model owner/operator preparing the tables P and T and publishing their encryptions, [symbol] P [symbol] and [symbol] T [symbol] . For each class Gᵢ for i from 1 to r, the data owner may compute

$$〚 Pr ( {G}_{i} \vert X ) 〛 = 〚 Pr ( {G}_{i} ) 〛 \cdot {\prod }_{j = 1}^{p} 〚 Pr ( {X}_{j} \vert {G}_{i} ) 〛 = 〚 {P}_{i} \cdot {\prod }_{j = 1}^{p} {T}_{i j} 〛 , \qquad ( 1 )$$

and the data owner may then compute

$$i = {argmax}_{1 \leq i \leq r} 〚 Pr ( {G}_{i} \vert X ) 〛 \qquad ( 2 )$$

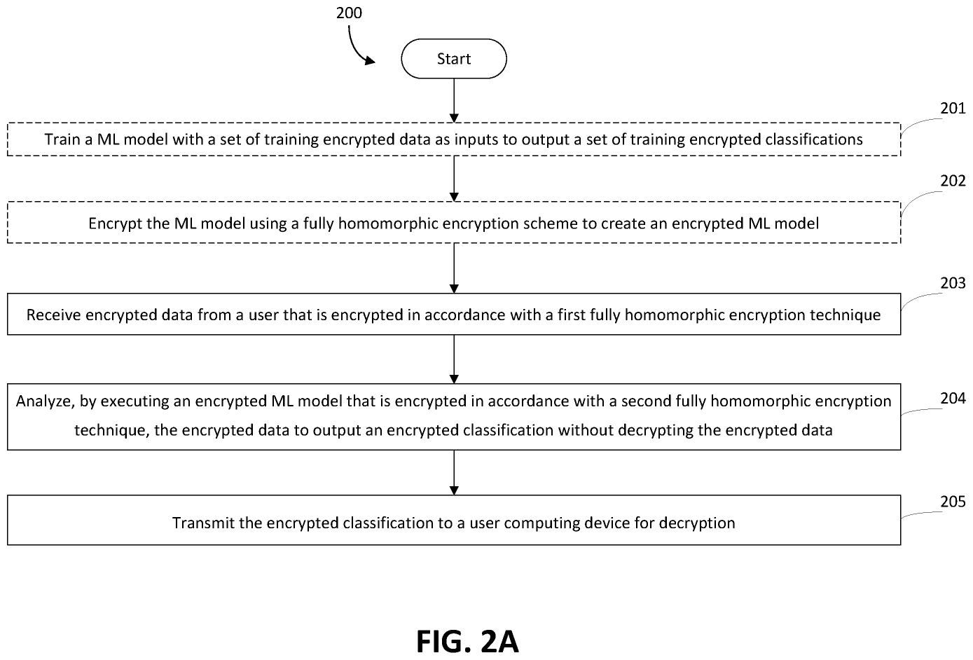

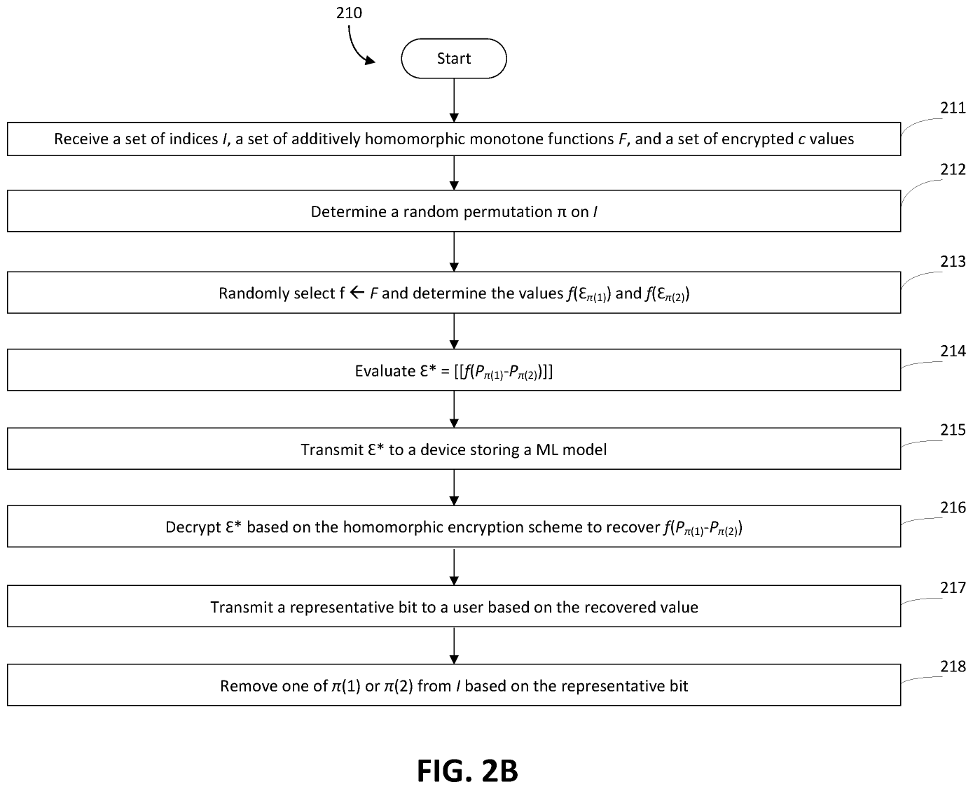

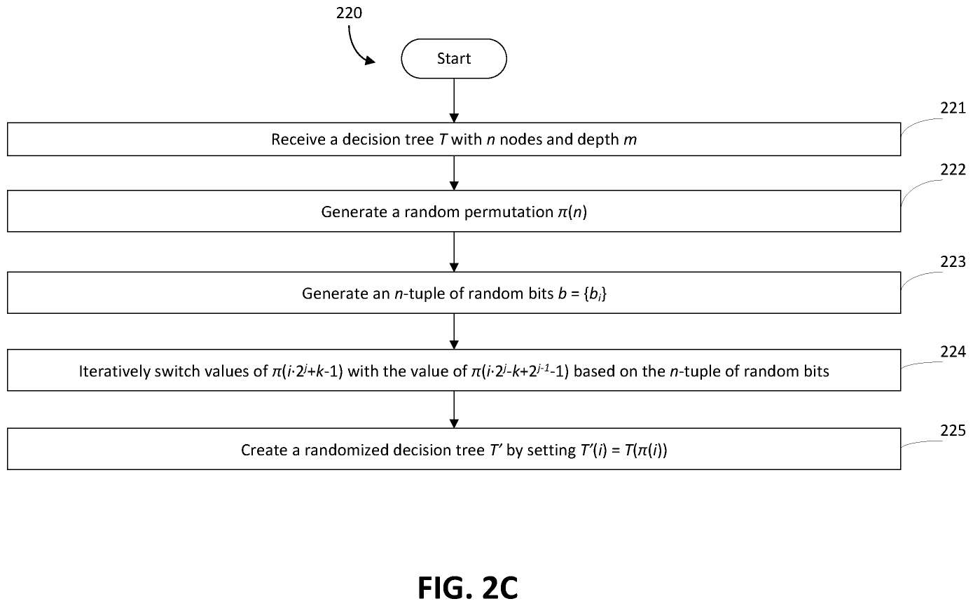

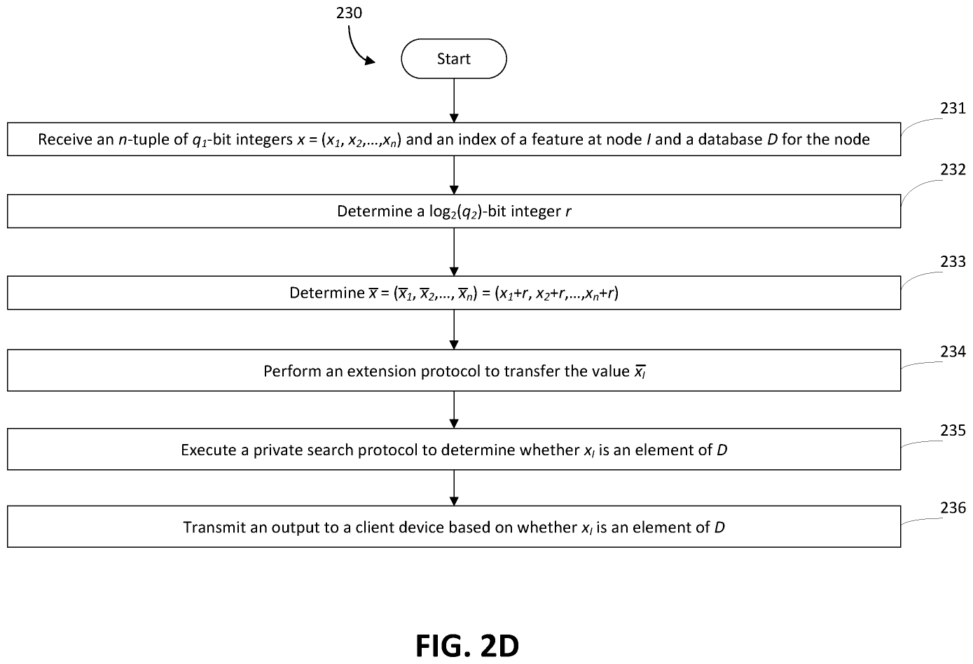

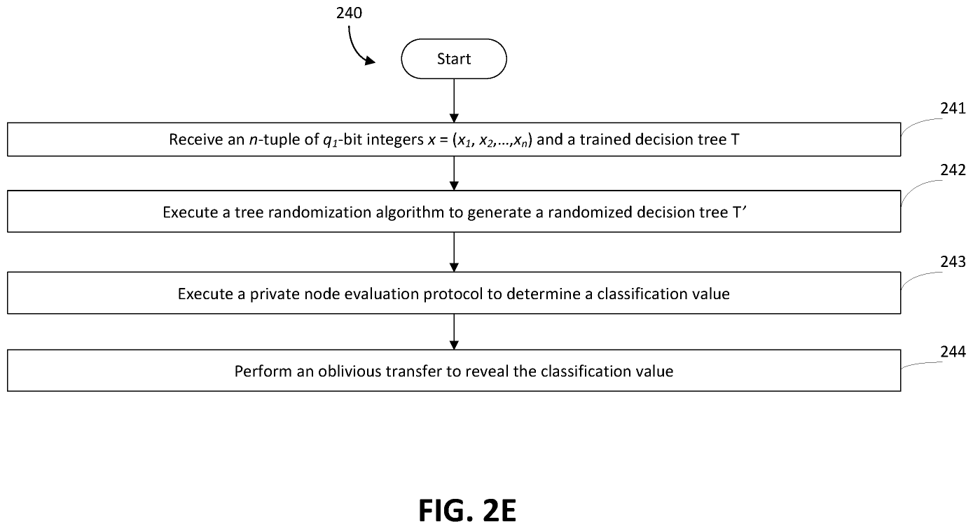

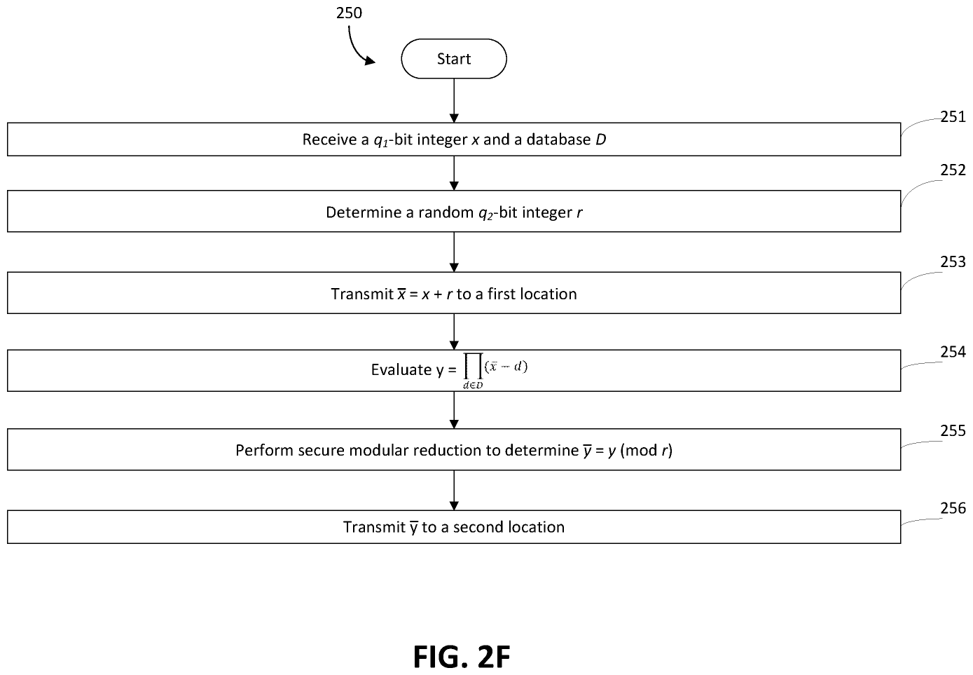

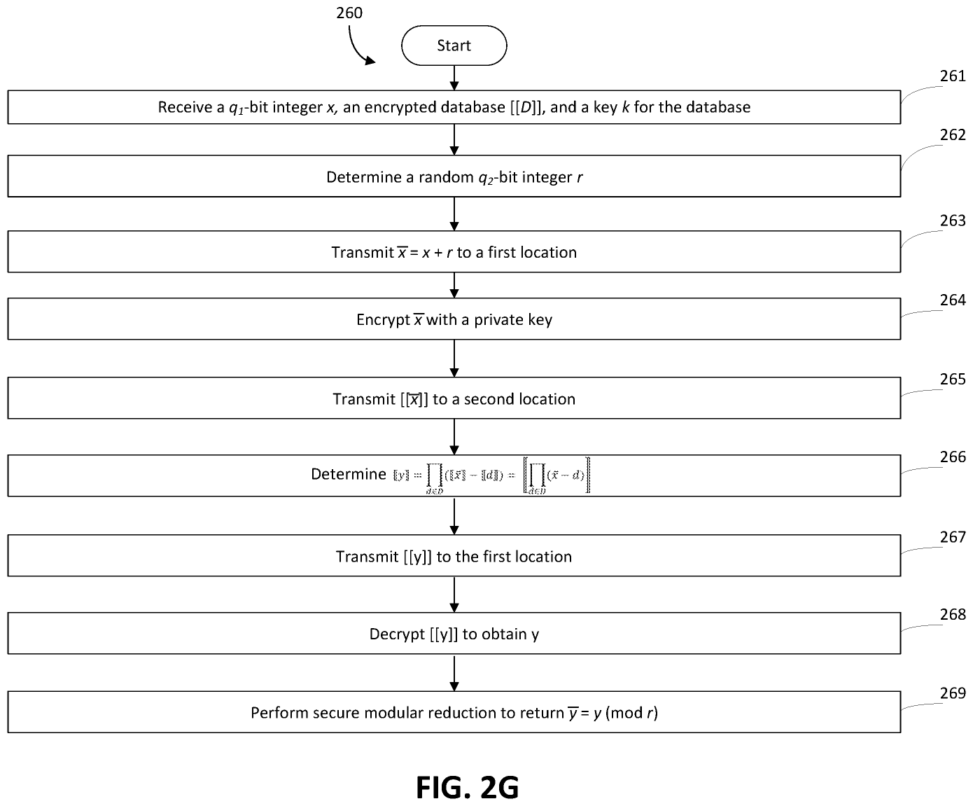

using, for example, the private argmax protocol described herein in reference to FIG. 2B.

Continuing this Naïve Bayes classification technique example, and as mentioned, there are two parties to consider when discussing the security of this protocol: the privacy of the data owner's information (e.g., user data 108b1) as well as the privacy of the classification model owner's learned/trained model (e.g., ML model 106b). The privacy of the learned/trained model may be derived from the security of the encryption technique used. The privacy of the data owner's information, however, relates to the argmax protocol referenced in equation (2).

A private argmax protocol using public-key encryption allows the data owner to mask their value with random noise encrypted under the model owner's public key. However, this approach does not work with private-key encryption because the data owner cannot encrypt random noise. To overcome these challenges with traditional private-key encryption, the techniques described herein enable data owners to compute argmax in a private-key FHE protocol.

Such a private-key FHE protocol may include denoting Pᵢ=Pr(Gᵢ|X), ε₁= [symbol] Pᵢ [symbol] , and the set of all encrypted probabilities E; as E. The protocol may include the data owner computing argmax by sending the set of encrypted probability values E to M. The model owner may then decrypt each value and transmit the index of the highest value to the data owner using an asymmetric encryption protocol to hide the value of the index from an cavesdropper. While the data owner has learned nothing about the encrypted model, the model owner learns not only which class the data owner's datapoint belongs to, but also the exact probabilities for each class.

Additionally, or alternatively, the data owner's device (e.g., user device 108) may perform a permutation π on the class probabilities then transmit x (E) to the model owner. In this embodiment, the model owner's device (e.g., model server 106) may decrypt the values, determine which value is largest, and transmit the index associated with that largest value to the data owner, who reverses the permutation x to determine the class (or classification). Importantly, in this embodiment, it is not necessary for the example system 120 to hide the value of the index sent to the data owner (e.g., to the user device 108) from any cavesdroppers in this scenario, as the permutation a randomized the value. However, while the protocol of this embodiment prevents the model owner from determining which probability is associated with each class, the protocol does not prevent the model owner from learning the class probabilities themselves.

Accordingly, the data owner device (e.g., user device 108) may attempt to hide the class probabilities by breaking down the computation of argmax to a series of comparisons. In particular, the user device 108 may randomly select two encrypted probabilities εᵢ, εⱼ∈ε and transmit a value represented by

$$ℰ *= {ℰ}_{i} - {ℰ}_{j} = 〚 {P}_{i} - {P}_{j} 〛 \qquad ( 3 )$$

to the model server 106. When the model server 106 decrypts ε* the model server 106 may also determine the value Pᵢ−Pⱼε(−p/, p/2], but may not have and/or otherwise determine either of the probabilities themselves. If this value is negative, the model server 106 may transmit the bit b=0 to the user device 108, and the model server 106 may transmit the bit b=1 otherwise. In this manner, the model server 106 may be able to determine which value was larger based on the initial selection of Pᵢ and Pⱼ and may be able to rule out the smaller of the two values. The procedure may be repeated until only one value remains.

Because the value represented by equation (3) sent to the model server 106 may be randomly ordered, publishing the bit 0 or 1 will also appear random to any observer, such that this bit publishing/transmission does not compromise the privacy of the data owner. However, the model server 106 recovers some partial information about the user data 108b1 stored on the user device 108. In particular, the model server 106 may recover a collection of r values representing a difference between pairs of the posterior probabilities for different i∈[r]. While permuting the elements keeps the model server 106 from determining which pairs of elements correspond to which values, it is not impossible for the model server 106 to determine partial information about the user data 108b1 based on this information.

To avoid this, the user device 108 may mask the value given by the difference between each pair of probabilities. Namely, the user device 108 may take advantage of the fully homomorphic properties of this protocol by constructing a family F of additively homomorphic, monotone functions that commute with encryption. Briefly, a function ƒ: R→R commutes with encryption if ƒ( [symbol] m [symbol] )= [symbol] ƒ(m) [symbol] . The additively homomorphic property of ƒ guarantees that ƒ(m+n)=ƒ(m)+ƒ(n). With the family of functions F, the user device 108 may execute a privacy-preserving algorithm for argmax, as described herein, for example, in reference to FIG. 2B.

During execution of such an algorithm the model server 106 may collect r values representing the result of a monotone function applied to the difference between random pairs of the posterior probabilities. Advantageously, the application of an unknown monotone function to this difference prevents the model server 106 from determining partial information from the decrypted value, thereby increasing the overall privacy/security of the user data 108b1.

Of course, this argmax protocol and Naïve Bayes classification technique described in the previous example may represent a portion of the potential protocols, techniques, and/or other algorithms that are contemplated as part of the techniques described herein. For example, FIGS. 2C and 2E describe decision tree randomization/classification algorithms, FIG. 2D describes a private node evaluation protocol, FIG. 2E describes a third-party private search (TPPS) algorithm, and FIG. 2G describes a TPPS over an encrypted database algorithm.

To provide more detail regarding many of the processes described herein (e.g., training the ML model 106b, encrypting data/models, generating encrypted classifications, etc.) FIGS. 2A-2G illustrate example methods for classifying encrypted data using an encrypted ML model, in accordance with various aspects disclosed herein. These example methods may describe many different methods for encrypting and implementing various ML models to perform such encrypted data classification. However, it should be understood that these example methods are for the purposes of discussion only, and that other methods utilizing other ML techniques and/or encryption techniques are contemplated herein.

FIG. 2A illustrates an example method 200 for classifying encrypted data using an encrypted ML model, in accordance with various aspects disclosed herein. For case of discussion, many of the various actions included in the example methods 200, 210, 220, 230, 240, 250, 260 may be described herein as performed by or with the use of a processor (e.g., processors 104a, 108a). However, it is to be appreciated that the various actions included in the example methods 200, 210, 220, 230, 240, 250, 260 may be performed by, for example, any suitable processing device (e.g., central server 104, model server 106, user device 108) executing the training module 106a, 104b2, the ML model 106b, 104b1, the encryption instructions 106c, 108b2, and/or other suitable modules/models/applications or combinations thereof.

At block 201, the example method 200 optionally includes training a ML model with a set of training encrypted data as inputs to output a set of training encrypted classifications. The example method 200 may further optionally include encrypting the ML model using a fully homomorphic encryption technique to create an encrypted ML model (block 202). The example method 200 may further include receiving encrypted data from a user that is encrypted in accordance with a first fully homomorphic encryption technique (block 203).

In some examples, the example method 200 further includes receiving encrypted data from a user device and determining, at the recipient device (e.g., central server 104, model server 106), that the received data has been encrypted using an FHE scheme/technique or that at least a portion of the received data has been encrypted using an FHE technique. In some such examples, the user device may send metadata and/or other data identifying that an FHE technique was used to encrypt the received data. In certain examples, the recipient device may determine that an FHE technique was used to encrypt the received data by analyzing data included as part of the received data indicating that such an FHE technique was used.

The example method 200 may further include analyzing, by executing an encrypted ML model that is encrypted in accordance with a second fully homomorphic encryption technique, the encrypted data to output an encrypted classification without decrypting the encrypted data (block 204). The example method 200 may further include transmitting the encrypted classification to a user computing device for decryption (block 205).

In some embodiments, encrypting the ML model may further include encrypting one or more parameters of the ML model using the second fully homomorphic encryption technique. In some embodiments, the ML model may include (i) a Naïve Bayes model, (ii) a Decision Tree, and/or (iii) a Random Forest model.

In some embodiments, the fully homomorphic encryption technique further includes a private key encryption technique. In some embodiments, the first fully homomorphic technique is different from the second fully homomorphic encryption technique. In some embodiments, the encrypted data from the user includes: (i) a set of encrypted values, (ii) a set of additively homomorphic monotone functions, (iii) a set of indexes, (iv) a q₁-bit integer, and/or (v) an n-tuple q₁-bit integer.

In some embodiments, the example method 200 further includes receiving a second set of encrypted data from a second user that is encrypted in accordance with the second fully homomorphic encryption technique, and the second set of encrypted data includes (i) a feature index at a node, (ii) a database, and/or (iii) a private encryption key for the database.

In some embodiments, the example method 200 further includes producing an encrypted update to a ML model with a set of training encrypted data as inputs from one or more users; transmitting the encrypted update to each user of the one or more users for decryption; and updating the ML model using the encrypted update.

In some embodiments, the example method 200 further includes receiving, from each user of a plurality of users, a training dataset encrypted using an independently generated key pair, in accordance with a multi-key, multi-hop fully homomorphic encryption technique. The example method 200 may further include training, with the training datasets, a ML model using a ML training technique and receiving encrypted test datasets from one or more users of the plurality of users. The example method 200 may further include generating, by executing the ML model, encrypted outputs for each encrypted test dataset, and causing user computing devices of each of the one or more users to participate in on-the-fly, multiparty computation to decrypt one or more respective encrypted outputs of the encrypted outputs by transmitting the encrypted outputs to each respective user of the one or more users.

In some embodiments, the example method 200 further includes receiving, from a new user, a new training dataset encrypted using a new independently generated key pair, in accordance with the multi-key, multi-hop fully homomorphic encryption technique; and updating the ML model with the new training dataset using the ML technique without re-encrypting the training datasets.

FIG. 2B illustrates another example method 210 for classifying encrypted data using an encrypted ML model, in accordance with various aspects disclosed herein. Generally speaking, the example method 210 may represent a privacy preserving argmax algorithm for generating classifications of input user data.

At block 211, the example method 210 includes receiving a set of indices/={1, 2, . . . , c}, a set of additively homomorphic monotone functions F, and a set of c values that may be encrypted by the model server 106 using a private key. The example method 210 may further include determining a random permutation x on/(block 212). The example method 210 may further include randomly selecting a function ƒ→F and determining the values ƒ(ε_{π(1)} and ƒ(ε_{π(2)}) (block 213). The example method 210 may further include evaluating

$$ℰ *= 〚 f ( P π ( 1 ) - P π ( 2 ) ) 〛 \qquad ( 4 )$$

based on the additive homomorphic properties of the encryption technique (block 214).

The example method 210 may further include transmitting ε* of equation (4) to a device storing a ML model (e.g., model server 106) (block 215). The example method 210 may further include decrypting ε* of equation (4) based on the homomorphic encryption technique to recover ƒ(P_{π(1)}−P_{π(2)}) (block 216). The example method 210 may further include transmitting a representative bit (e.g., b=1 or b=0) to a user based on the recovered value (block 217). Further, based on the representative bit transmitted to the user, the example method 210 may include removing one of π(1) or π(2) from/(block 218).

It should be appreciated that the example method 210 may include executing any suitable number of the actions therein any suitable number of times and/or in any suitable combination. For example, any/all/some of the actions associated with blocks 211 through 218 may be iteratively performed any suitable number of times, such as until |I|≤1.

FIG. 2C illustrates another example method 220 for classifying encrypted data using an encrypted ML model, in accordance with various aspects disclosed herein. Generally speaking, the example method 220 may represent a tree randomization algorithm for generating classifications of input user data.

At block 221, the example method 220 may include receiving a decision tree T with n nodes and depth m. The example method 220 may further include generating a random permutation π(n) (block 222). The example method 220 may further include generating an n-tuple of random bits b={bᵢ} (block 223). These random bits may generally denote whether a decision made by a node will be reversed.

If the node is reversed, the subtrees stemming from the children nodes may be swapped. In other words, and as indicated at block 224, the example method 220 may further include iteratively switching values of π(i·2^{j}+k−1) with the value of π(i·2^{j}−k+2^{j-1}−1) based on the n-tuple of random bits. The example method 220 may further include creating a randomized decision tree T′ by setting T′(i)=T(π(i)) (block 225).

It should be appreciated that the example method 220 may include executing any suitable number of the actions therein any suitable number of times and/or in any suitable combination. For example, any/all/some of the actions associated with blocks 221 through 225 may be iteratively performed any suitable number of times, such as while i ranges from 1 to n.

FIG. 2D illustrates another example method 230 for classifying encrypted data using an encrypted ML model, in accordance with various aspects disclosed herein. Generally speaking, the example method 230 may represent a private node evaluation protocol for generating classifications of input user data.

At block 231, the example method 230 may include receiving an n-tuple of q₁-bit integers x=(x₁, x₂, . . . , xₙ) and an index of a feature at node/and a database D for the node. The n values referenced in this example method 230 may correspond to, for example, n features used within the encrypted ML model. The example method 230 may further include determining a log₂(q₂)-bit integer r (block 232), which may correspond to parameters of a TTPS protocol, as described herein.

The example method 230 may further include determining x̅=(x̅₁̅, x̅₂̅, . . . , xₙ)=(x₁+r, x₂+r, . . . , xₙ+r) (block 233). The example method 230 may further include performing an extension protocol to transfer the value x̅₁̅ from the model owner (e.g., model server 106) to the data owner (e.g., user device 108) (block 234). The value I∈{1, 2, . . . , n} may be the index of the decision variable on the node. The example method 230 may further include executing a private search protocol to determine whether x₁ is an element of D (i.e., whether x₁∈D) (block 235). For example, the example method 230 may include executing a TTPS to determine whether x₁∈D.

The example method 230 may further include transmitting an output to a client device (e.g., user device 108) based on whether x, is an element of D (block 236). For example, the example method 230 may include transmitting an output of 1 if x₁∈D. By contrast, the example method 230 may include transmitting an output of 0 if x₁ is not an element of D.

It should be appreciated that the example method 230 may include executing any suitable number of the actions therein any suitable number of times and/or in any suitable combination.

FIG. 2E illustrates another example method 240 for classifying encrypted data using an encrypted ML model, in accordance with various aspects disclosed herein. Generally speaking, the example method 240 may represent a private decision tree classification algorithm for generating classifications of input user data.

Prior to performing the actions of the example method 240, a data model owner may train (e.g., via model server 106) a binary decision tree, T, under any suitable algorithm, such as the classification and regression tree (CART) algorithm. This binary decision tree T may be a complete tree of depth n consisting of 2ⁿ−1 nodes. In certain embodiments, some of these nodes may be dummy nodes. Each decision node may be denoted by ti with a corresponding decision function ƒᵢ for i from 1 to 2ⁿ⁻¹−1. The leaf nodes may be denoted by tᵢ with class assignment cᵢ for i from 2ⁿ−1 to 2ⁿ−1. The model owner may store this tree on a server (e.g., model server 106), and the data owner may have a data point with n features, x=(x₁, x₂, . . . , xₙ).

The data owner may desire to classify the data point using the tree, T, so the user device 108 may compute a binary decision function ƒᵢ on each decision node tᵢ to determine the tree path. The user device 108 may then also retrieve a class assignment cᵢ which corresponds to the determined tree path.

To achieve several of the privacy benefits described herein, each step in this procedure must be randomized, as illustrated in the example method 240 of FIG. 2E. Thus, after receiving the n-tuple of q₁-bit integers x=(x₁, x₂, . . . , (n) and a trained decision tree T (block 241), the example method 240 may include executing a tree randomization algorithm to generate a randomized decision tree T′ (block 242).

Furthermore, the data owner may require a privacy-preserving method of determining the relevant path in the randomized decision tree, T′. In certain embodiments, every node in the randomized decision tree T′ must be queried to avoid enabling the model server (e.g., model server 106) being able to determine the path followed based on the data owner queries, and thereafter leverage a colluding server to determine the relevant classification.

In any event, the example method 240 may further include executing a private node evaluation protocol to determine a classification value (block 243). For example, the example method 240 may include utilizing a TPPS protocol to perform classification, and thereby yield the classification value. The example method 240 may further include performing an oblivious transfer to reveal the classification value (block 244).

It should be appreciated that the example method 240 may include executing any suitable number of the actions therein any suitable number of times and/or in any suitable combination. For example, any/all/some of the actions associated with blocks 241 through 244 may be iteratively performed any suitable number of times, such as while node i is an element of the randomized decision tree, T′.

FIG. 2F illustrates another example method 250 for classifying encrypted data using an encrypted ML model, in accordance with various aspects disclosed herein. Generally speaking, the example method 250 may represent a TPPS algorithm for generating classifications of input user data.

At block 251, the example method 250 includes receiving a q₁-bit integer x and a database D. In certain embodiments, the database D may include entries of size at most q₁ bits each. The example method 250 may further include determining a random q₂-bit integer r (block 252). The example method 250 may further include transmitting x̅=x+r to a first location (e.g., central server 104, model server 106) (block 253).

The example method 250 may further include evaluating

$$y = {\prod }_{d ∈ D} ( \overline{x} - d ) \qquad ( 5 )$$

(block 254). The example method 250 may further include performing secure modular reduction to determine y̅=y (mod r) based on equation (5) (block 255). The example method 250 may further include transmitting y̅ to a second location (e.g., user device 108). Namely, if y̅=0, then the example method 250 may include transmitting the value/classification 1 to the second location. By contrast, if y̅≠0, then the example method 250 may include transmitting the value/classification 0 to the second location.

It should be appreciated that the example method 240 may include executing any suitable number of the actions therein any suitable number of times and/or in any suitable combination.

FIG. 2G illustrates another example method 260 for classifying encrypted data using an encrypted ML model, in accordance with various aspects disclosed herein. Generally speaking, the example method 260 may represent a TPPS over an encrypted database algorithm for generating classifications of input user data.

At block 261, the example method 260 may include receiving a q₁-bit integer x, an encrypted database [symbol] D [symbol] encrypted under a fully homomorphic encryption technique, and a key k for the database (block 261). The example method 260 may further include determining a random q₂-bit integer r (block 262). The example method 260 may further include transmitting x̅=x+r to a first location (e.g., central server 104, model server 106) (block 263).

At block 264, the example method 260 may include encrypting x̅ with a private key. The example method 260 may further include transmitting the encrypted x, [symbol] x [symbol] to a second location (e.g., central server 104, model server 106) (block 265). The processors at the second location may then determine

$$〚 y 〛 = {\prod }_{d ∈ D} ( 〚 \overline{x} 〛 - 〚 d 〛 ) = 〚 {\prod }_{d ∈ D} ( \overline{x} - d ) 〛 \qquad ( 6 )$$

(block 266). The example method 260 may further include transmitting [symbol] y [symbol] from equation (6) to the first location (block 267). The example method 260 may further include decrypting [symbol] y [symbol] to obtain y (block 268). The example method 260 may further include performing secure modular reduction to return y̅=y (mod r) (block 269). Namely, if y̅=0, then the example method 260 may include transmitting the value/classification 1 to a third location (e.g., user device 108). By contrast, if y̅≠0, then the example method 260 may include transmitting the value/classification 0 to the third location.

It should be appreciated that the example method 260 may include executing any suitable number of the actions therein any suitable number of times and/or in any suitable combination.

### Aspects of the Disclosure

1. A system for classifying encrypted data using an encrypted machine learning (ML) model, the system comprising: a memory storing a set of computer-readable instructions including an encrypted ML model; and a processor interfacing with the memory, and configured to execute the set of computer-readable instructions to cause the system to: receive encrypted data from a user that is encrypted in accordance with a first fully homomorphic encryption technique, analyze, by executing the encrypted ML model that is encrypted in accordance with a second fully homomorphic encryption technique, the encrypted data to output an encrypted classification without decrypting the encrypted data, and transmit the encrypted classification to a user computing device for decryption.

2. The system of aspect 1, wherein the set of computer-readable instructions, when executed, further cause the system to: train a ML model with a set of training encrypted data as inputs to output a set of training encrypted classifications of the set of training encrypted data; and encrypt the ML model using the second fully homomorphic encryption technique to create the encrypted ML model.

3. The system of aspect 2, wherein encrypting the ML model further comprises: encrypt one or more parameters of the ML model using the second fully homomorphic encryption technique.

4. The system of any of aspects 1 through 3, wherein the ML model comprises: (i) a Naïve Bayes model, (ii) a Decision Tree, or (iii) a Random Forest model.

5. The system of any of aspects 1 through 4, wherein the fully homomorphic encryption technique further includes a private key encryption technique.

6. The system of any of aspects 1 through 5, wherein the first fully homomorphic technique is different from the second fully homomorphic encryption technique.

7. The system of any of aspects 1 through 6, wherein the encrypted data from the user comprises: (i) a set of encrypted values, (ii) a set of additively homomorphic monotone functions, (iii) a set of indexes, (iv) a q₁-bit integer, or (v) an n-tuple q₁-bit integer.

8. The system of any of aspects 1 through 7, wherein the set of computer-readable instructions, when executed, further cause the system to: receive a second set of encrypted data from a second user that is encrypted in accordance with the second fully homomorphic encryption technique, and wherein the second set of encrypted data comprises: (i) a feature index at a node, (ii) a database, or (iii) a private encryption key for the database.

9. The system of any of aspects 1 through 8, wherein the set of computer-readable instructions, when executed, further cause the system to: produce an encrypted update to a ML model with a set of training encrypted data as inputs from one or more users; transmit the encrypted update to each user of the one or more users for decryption; and update the ML model using the encrypted update.

10. The system of any of aspects 1 through 9, wherein the set of computer-readable instructions, when executed, further cause the system to: receive, from each user of a plurality of users, a training dataset encrypted using an independently generated key pair, in accordance with a multi-key, multi-hop fully homomorphic encryption technique; train, with the training datasets, a ML model using a ML training technique; receive encrypted test datasets from one or more users of the plurality of users; generate, by executing the ML model, encrypted outputs for each encrypted test dataset; and cause user computing devices of each of the one or more users to participate in on-the-fly, multiparty computation to decrypt one or more respective encrypted outputs of the encrypted outputs by transmitting the encrypted outputs to each respective user of the one or more users.

11. The system of aspect 10, wherein the set of computer-readable instructions, when executed, further cause the system to: receive, from a new user, a new training dataset encrypted using a new independently generated key pair, in accordance with the multi-key, multi-hop fully homomorphic encryption technique; and update the ML model with the new training dataset using the ML technique without re-encrypting the training datasets.

12. A computer-implemented method for classifying encrypted data using an encrypted machine learning (ML) model, the method comprising: receiving, at one or more processors, encrypted data from a user that is encrypted in accordance with a first fully homomorphic encryption technique; analyzing, by the one or more processors executing an encrypted ML model that is encrypted in accordance with a second fully homomorphic encryption technique, the encrypted data to output an encrypted classification without decrypting the encrypted data; and transmitting, by the one or more processors, the encrypted classification to a user computing device for decryption.

13. The computer-implemented method of aspect 12, further comprising: training, by the one or more processors, a ML model with a set of training encrypted data as inputs to output a set of training encrypted classifications of the set of training encrypted data; and encrypting, by the one or more processors, the ML model using the second fully homomorphic encryption technique to create the encrypted ML model.

14. The computer-implemented method of aspect 13, wherein encrypting the ML model further comprises: encrypting, by the one or more processors, one or more parameters of the ML model using the second fully homomorphic encryption technique.

15. The computer-implemented method of any of aspects 12 through 14, wherein the ML model comprises: (i) a Naïve Bayes model, (ii) a Decision Tree, or (iii) a Random Forest model.

16. The computer-implemented method of any of aspects 12 through 15, wherein the fully homomorphic encryption technique further includes a private key encryption technique.

17. The computer-implemented method of any of aspects 12 through 16, wherein the first fully homomorphic technique is different from the second fully homomorphic encryption technique.

18. The computer-implemented method of any of aspects 12 through 17, wherein the encrypted data from the user comprises: (i) a set of encrypted values, (ii) a set of additively homomorphic monotone functions, (iii) a set of indexes, (iv) a q₁-bit integer, or (v) an n-tuple q₁-bit integer.

19. The computer-implemented method of any of aspects 12 through 18, further comprising: receiving, at the one or more processors, a second set of encrypted data from a second user that is encrypted in accordance with the second fully homomorphic encryption technique, and wherein the second set of encrypted data comprises: (i) a feature index at a node, (ii) a database, or (iii) a private encryption key for the database.

20. A non-transitory computer readable medium comprising instructions for classifying encrypted data using an encrypted machine learning (ML) model that, when executed, may cause one or more processors to: receive encrypted data from a user that is encrypted in accordance with a first fully homomorphic encryption technique; analyze, by executing an encrypted ML model that is encrypted in accordance with a second fully homomorphic encryption technique, the encrypted data to output an encrypted classification without decrypting the encrypted data; and transmit the encrypted classification to a user computing device for decryption.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporancously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of the example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but also deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but also deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment,” “one aspect,” “an aspect,” or “an embodiment” means that a particular element, feature, structure, or characteristic described in connection with the embodiment is included in at least one embodiment/aspect. The appearances of the phrase “in one embodiment” or “in one aspect” in various places in the specification are not necessarily all referring to the same embodiment/aspect.

Some embodiments/aspects may be described using the expression “coupled” and “connected” along with their derivatives. For example, some embodiments/aspects may be described using the term “coupled” to indicate that two or more elements are in direct physical or electrical contact. The term “coupled,” however, may also mean that two or more elements are not in direct contact with each other, but yet still co-operate or interact with each other. The embodiments/aspects are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments/aspects herein. This is done merely for convenience and to give a general sense of the description. This description, and the claims that follow, should be read to include one or at least one and the singular also includes the plural unless it is obvious that it is meant otherwise.

While the present invention has been described with reference to specific examples, which are intended to be illustrative only and not to be limiting of the invention, it will be apparent to those of ordinary skill in the art that changes, additions and/or deletions may be made to the disclosed embodiments/aspects without departing from the spirit and scope of the invention.

The foregoing description is given for clearness of understanding; and no unnecessary limitations should be understood therefrom, as modifications within the scope of the invention may be apparent to those having ordinary skill in the art.

What is claimed:

1. A system for classifying encrypted data using an encrypted machine learning (ML) model, the system comprising:
a memory storing a set of computer-readable instructions including an encrypted ML model; and
a processor interfacing with the memory, and configured to execute the set of computer-readable instructions to cause the system to:
receive encrypted data from a user that is encrypted in accordance with a first fully homomorphic encryption technique,
analyze, by executing the encrypted ML model that is encrypted in accordance with a second fully homomorphic encryption technique, the encrypted data to output an encrypted classification without decrypting the encrypted data, and
transmit the encrypted classification to a user computing device for decryption.

2. The system of claim 1, wherein the set of computer-readable instructions, when executed, further cause the system to:
train a ML model with a set of training encrypted data as inputs to output a set of training encrypted classifications of the set of training encrypted data; and
encrypt the ML model using the second fully homomorphic encryption technique to create the encrypted ML model.

3. The system of claim 2, wherein encrypting the ML model further comprises:
encrypt one or more parameters of the ML model using the second fully homomorphic encryption technique.

4. The system of claim 1, wherein the encrypted ML model comprises: (i) a Naïve Bayes model, (ii) a Decision Tree, or (iii) a Random Forest model.

5. The system of claim 1, wherein the first fully homomorphic encryption technique or the second fully homomorphic encryption technique further includes a private key encryption technique.

6. The system of claim 1, wherein the first fully homomorphic encryption technique is different from the second fully homomorphic encryption technique.

7. The system of claim 1, wherein the encrypted data from the user comprises: (i) a set of encrypted values, (ii) a set of additively homomorphic monotone functions, (iii) a set of indexes, (iv) a q₁-bit integer, or (v) an n-tuple q₁-bit integer.

8. The system of claim 1, wherein the set of computer-readable instructions, when executed, further cause the system to:
receive a second set of encrypted data from a second user that is encrypted in accordance with the second fully homomorphic encryption technique, and
wherein the second set of encrypted data comprises: (i) a feature index at a node, (ii) a database, or (iii) a private encryption key for the database.

9. The system of claim 1, wherein the set of computer-readable instructions, when executed, further cause the system to:
produce an encrypted update to a ML model with a set of training encrypted data as inputs from one or more users;
transmit the encrypted update to each user of the one or more users for decryption; and
update the ML model using the encrypted update.

10. The system of claim 1, wherein the set of computer-readable instructions, when executed, further cause the system to:
receive, from each user of a plurality of users, a training dataset encrypted using an independently generated key pair, in accordance with a multi-key, multi-hop fully homomorphic encryption technique;
train, with the training datasets, a ML model using a ML training technique;
receive encrypted test datasets from one or more users of the plurality of users;
generate, by executing the ML model, encrypted outputs for each encrypted test dataset; and
cause user computing devices of each of the one or more users to participate in on-the-fly, multiparty computation to decrypt one or more respective encrypted outputs of the encrypted outputs by transmitting the encrypted outputs to each respective user of the one or more users.

11. The system of claim 10, wherein the set of computer-readable instructions, when executed, further cause the system to:
receive, from a new user, a new training dataset encrypted using a new independently generated key pair, in accordance with the multi-key, multi-hop fully homomorphic encryption technique; and
update the ML model with the new training dataset using the ML training technique without re-encrypting the training datasets.

12. A computer-implemented method for classifying encrypted data using an encrypted machine learning (ML) model, the method comprising:
receiving, at one or more processors, encrypted data from a user that is encrypted in accordance with a first fully homomorphic encryption technique;
analyzing, by the one or more processors executing an encrypted ML model that is encrypted in accordance with a second fully homomorphic encryption technique, the encrypted data to output an encrypted classification without decrypting the encrypted data; and
transmitting, by the one or more processors, the encrypted classification to a user computing device for decryption.

13. The computer-implemented method of claim 12, further comprising:
training, by the one or more processors, a ML model with a set of training encrypted data as inputs to output a set of training encrypted classifications of the set of training encrypted data; and
encrypting, by the one or more processors, the ML model using the second fully homomorphic encryption technique to create the encrypted ML model.

14. The computer-implemented method of claim 13, wherein encrypting the ML model further comprises:
encrypting, by the one or more processors, one or more parameters of the ML model using the second fully homomorphic encryption technique.

15. The computer-implemented method of claim 12, wherein the encrypted ML model comprises: (i) a Naïve Bayes model, (ii) a Decision Tree, or (iii) a Random Forest model.

16. The computer-implemented method of claim 12, wherein the first fully homomorphic encryption technique or the second fully homomorphic encryption technique further includes a private key encryption technique.

17. The computer-implemented method of claim 12, wherein the first fully homomorphic encryption technique is different from the second fully homomorphic encryption technique.

18. The computer-implemented method of claim 12, wherein the encrypted data from the user comprises: (i) a set of encrypted values, (ii) a set of additively homomorphic monotone functions, (iii) a set of indexes, (iv) a q₁-bit integer, or (v) an n-tuple q₁-bit integer.

19. The computer-implemented method of claim 12, further comprising:
receiving, at the one or more processors, a second set of encrypted data from a second user that is encrypted in accordance with the second fully homomorphic encryption technique, and
wherein the second set of encrypted data comprises: (i) a feature index at a node, (ii) a database, or (iii) a private encryption key for the database.

20. A non-transitory computer readable medium comprising instructions for classifying encrypted data using an encrypted machine learning (ML) model that, when executed, may cause one or more processors to:
receive encrypted data from a user that is encrypted in accordance with a first fully homomorphic encryption technique;
analyze, by executing an encrypted ML model that is encrypted in accordance with a second fully homomorphic encryption technique, the encrypted data to output an encrypted classification without decrypting the encrypted data; and
transmit the encrypted classification to a user computing device for decryption.
